(19) United States
(12) Patent Application Publication
(10) Pub. No.: US 2022/0067830 A1
(43) Pub. Date: Mar. 3, 2022

(54) AUTOMATED INVENTORY MANAGEMENT

(71) Applicant: Saudi Arabian Oil Company, Dhahran (SA)

(72) Inventor: Rami Zayed Amri, Dhahran (SA)

(21) Appl. No.: 17/003,271

(22) Filed: Aug. 26, 2020

(51) Int. Cl. G06Q 40/04; G06Q 40/00; G06Q 50/28; G06Q 50/18; G06N 20/00; G06N 5/04

(52) U.S. Cl. CPC G06Q 40/04; G06Q 40/12; G06N 5/04; G06Q 50/18; G06N 20/00; G06Q 50/28

(57) ABSTRACT

Disclosed are methods, systems, and computer-readable medium to perform operations including: calculating a current weight of a bought-in material over a current period; calculating a current weighted unit price of the bought in material; calculating a historical weighted average price of the bought-in material during a historical period; calculating a difference between the current weighted unit price and the historical weighted average price; calculating a material price percentage change by dividing the difference by the historical weighted average price; multiplying the material price percentage change by the current weight to obtain a weighted average percentage change for the bought-in material; and performing one or more actions in connection with the weighted average percentage change.

### TECHNICAL FIELD

This disclosure relates to an automated inventory and supply chain management system.

### BACKGROUND

An enterprise, for example, an oil and gas corporation, may spend significant capital on procuring materials and commodities from external vendors. These purchases are documented by purchase orders (POs) that include information such as, supplier or vendor, delivery address, item identifier (for example, name or code), item cost, item quantity, total item price, and total order cost. The enterprise may store these POs in a database.

### SUMMARY

This disclosure describes an inventory management system (IMS) for calculating price change trends for materials procured by an enterprise, and for performing actions in connection with the calculated trends (for example, actions based on a price change trend). The IMS also analyzes the price change trends to generate insights on price change trends (for example, cost impact of high spend materials), both on an overall enterprise level and on a commodity level. The IMS can also display the price change trends, insights on the price change trends, and recommendations on a graphical user interface (GUI). In some implementations, the IMS interacts with external procurement systems to automatically negotiate contracts, look for new vendors, submit offers, and create orders based on the price change trends. Additionally, the IMS can interact with external systems, such as smart factories or smart shipping providers, to prompt and act on actions, such as ordering, shipping, and transporting.

Aspects of the subject matter described in this specification may be embodied in methods that include the actions of: calculating a current weight of a bought-in material over a current period; calculating a current weighted unit price of the bought in material; calculating a historical weighted average price of the bought-in material during a historical period; calculating a difference between the current weighted unit price and the historical weighted average price; calculating a material price percentage change by dividing the difference by the historical weighted average price; multiplying the material price percentage change by the current weight to obtain a weighted average percentage change for the bought-in material; and performing one or more actions in connection with the weighted average percentage change.

The previously-described implementation is applicable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, calculating the current weight of the bought-in material involves: extracting from a purchase order database: (i) a plurality of purchase orders for the bought-in material during the current period and (ii) costs associated with the plurality of purchase orders; calculating a total cost of the plurality of purchase orders for the bought-in material; calculating a total cost of all purchase orders during the current period; and dividing the total cost of the plurality of purchase orders for the bought-in material by the total cost of all purchase orders to obtain the current weight of the bought-in material.

In some implementations, calculating the current weighted unit price of the bought-in material involves: for each of a plurality of purchase orders for the bought-in material: dividing a respective cost of the purchase order by a total material placement value during the current period to obtain a respective unit price weight; and multiplying the respective unit price weight with a respective effective unit price to obtain a respective weighted unit price; summing the respective weighted unit prices to obtain the current weighted unit price of the bought-in material.

In some implementations, the current weight of the material is calculated based on a plurality of purchase orders for the material during the current period, and wherein the plurality of purchase orders have at least one of an identical incoterm, purchasing office, or order unit of measurement.

In some implementations, performing one or more actions in connection with the weighted average percentage change involves: determining the weighted average percentage change and a threshold change in a price of the material; and responsively generating an alert indicative of the threshold change.

In some implementations, performing one or more actions in connection with the weighted average percentage change involves: generating, based on the weighted average percentage change, an offer for a purchase of the material; and submitting the offer to a system of an external vendor for the material.

In some implementations, performing one or more actions in connection with the weighted average percentage change involves: generating a representation of a graphical user interface (GUI), where the GUI contains: one or more panes including a representation of the weighted average percentage change.

In some implementations, method 400 further involves calculating respective weighted average percentage changes for a plurality of materials; and calculating, based on the respective weighted average percentage changes, an overall weighted average percentage change.

In some implementations, performing one or more actions in connection with the weighted average percentage change involves using ML or AI techniques to analyze the calculated price change trends and to generate recommendations based on the trends. An ML model can be trained using price change trends. As an example, an ML model can be trained to generate data indicative of the prices of the materials procured by the enterprise. As another example, an ML model can be trained to predict future prices of materials. As yet another example, an ML model can be trained to identify price change trends that are indicative of certain events (for example, rapidly changing price, sudden change in price, prices that deviate from the market, among other examples).

The subject matter described in this specification can be implemented to realize one or more of the following advantages. The disclosed IMS applies a weighted impact when generating price change trends, which improves the accuracy and utility of the data. The IMS also has the ability to track prices on an overall enterprise level or drill down to a commodity and material level. Further, the IMS can perform actions in connection with the generated price change trends. For example, the IMS can generate alerts that indicate a threshold change in price. Additionally, the IMS can generate a procurement strategy for frequently procured materials with specific prices and specific vendors to establish long term agreements in order to avoid price uncertainty. Also, the system can use the generated price change trends to predict future prices of materials. Furthermore, the IMS provides visibility on high spend materials and determines a cost impact of those materials. The cost impact can be used to show savings or added costs. As such, procurement strategies can be established based on the data provided by the IMS, which in turn, can be used to generate purchase agreements for high impact materials in order to avoid increased costs.

The details of one or more implementations of the subject matter described in this disclosure are set forth in the accompanying drawings and the description. Other features, aspects, and advantages of the subject matter will become apparent from the description, the drawings, and the claims.

### BRIEF DESCRIPTION OF THE DRAWINGS

FIG. 1 illustrates a block diagram of an example inventory management system, according to some implementations of the present disclosure.

FIG. 2 illustrates an example workflow for calculating a price change trend of a material, according to some implementations of the present disclosure.

FIG. 3 illustrates an example graphical user interface (GUI), according to some implementations of the present disclosure.

FIG. 4 illustrates a flowchart of an example method, according to some implementations of the present disclosure.

FIG. 5 illustrates a block diagram of an example computer system, according to some implementations of present disclosure.

Like reference numbers and designations in the various drawings indicate like elements.

### DETAILED DESCRIPTION

This disclosure describes an inventory management system (IMS) for calculating price change trends for materials procured by an enterprise, and for performing actions in connection with the calculated trends (for example, an action based on a price change trend). Additionally, the IMS analyzes price change trends to generate insights (for example, cost impact of high spend materials) both on an overall enterprise level and on a commodity level. The IMS may also display on a graphical user interface (GUI) the price change trends, insights on the price change trends, and recommendations based on the price change trends. In some implementations, the IMS communicates with external procurement systems to automatically negotiate procurement contracts, search for new vendors, submit procurement offers, or create orders based on price change trends. Additionally, the IMS can communicate with external systems, such as smart factories or smart shipping providers, to prompt and act on actions, such as ordering, shipping, and transporting.

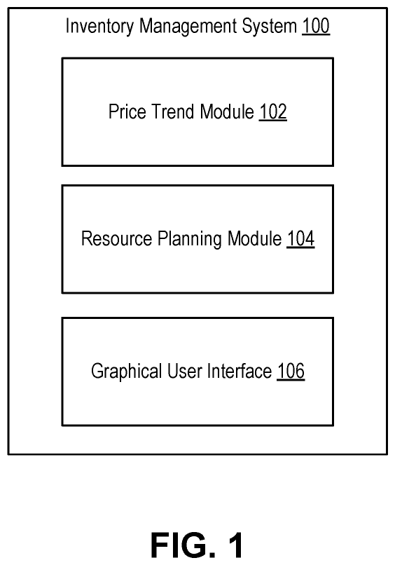

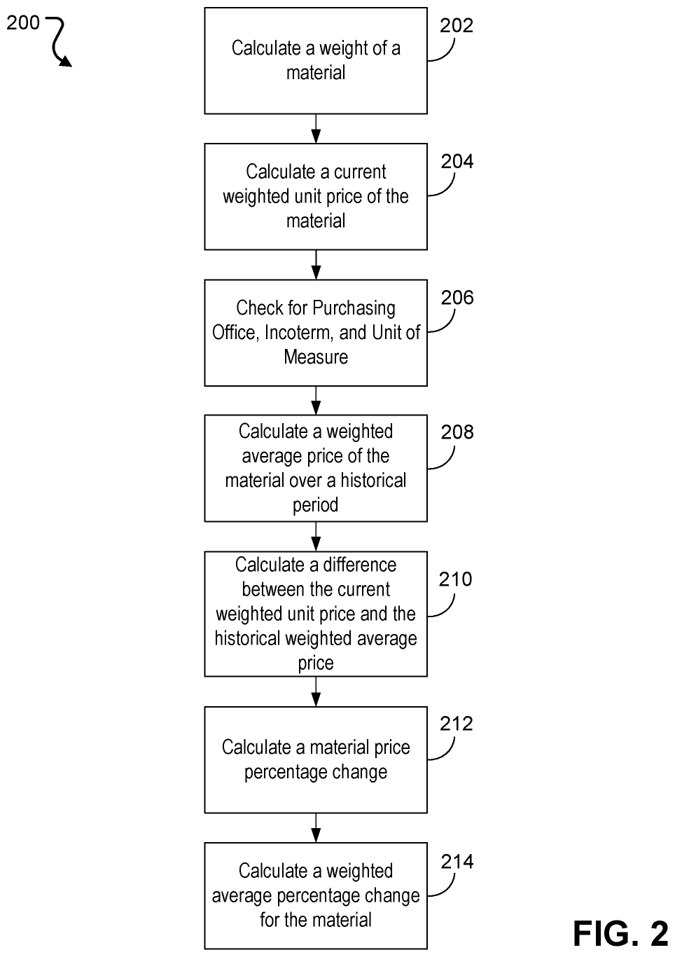

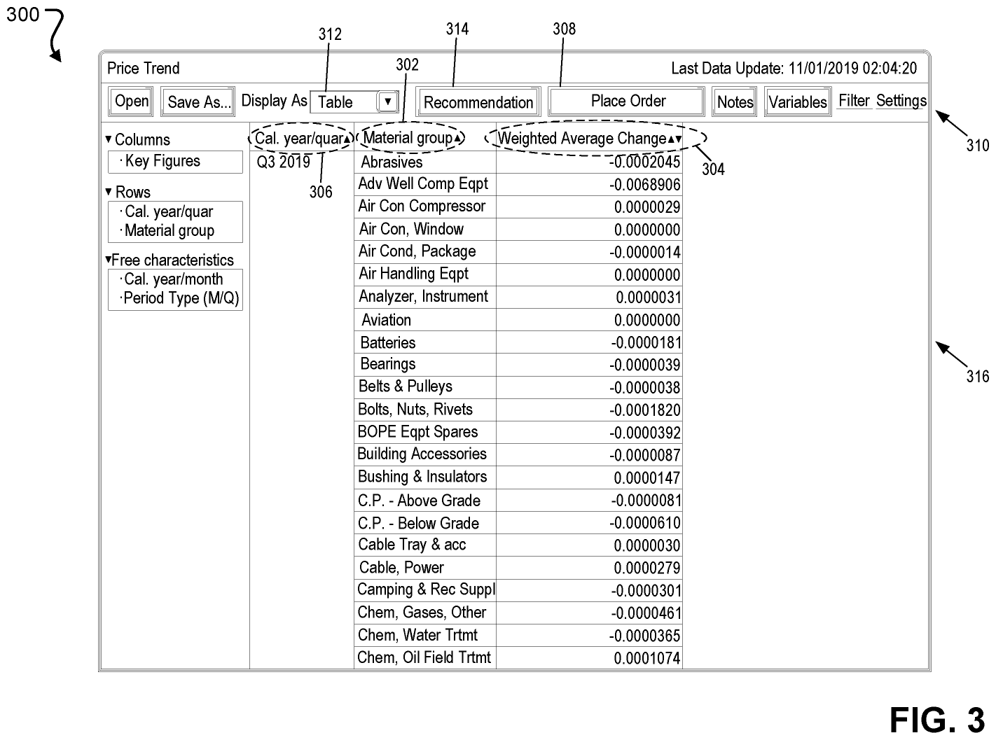

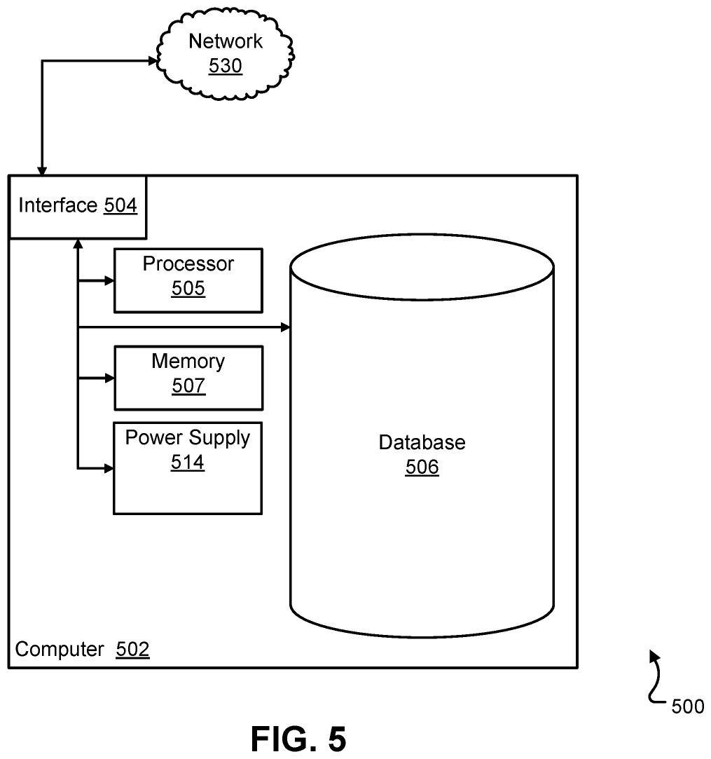

FIG. 1 illustrates an example block diagram of an inventory management system (IMS) 100, according to some implementations. The IMS 100 may, for example, be operated by an enterprise that procures materials and commodities from external vendors. As shown in FIG. 1, the IMS 100 includes a plurality of price trend module 102, a resource planning module 104, a graphical user interface 106, and a communication interface (not illustrated in FIG. 1). The IMS 100 may be implemented by a computing system, such as the computing system 500 of FIG. 5. Note that the IMS 100 is shown for illustration purposes only, as the IMS 100 may include additional components and/or have one or more components removed without departing from the scope of the disclosure. Further, note that the various components of the IMS 100 may be arranged and connected in any manner. In the following discussion of the IMS 100, reference is also made to FIG. 2 and FIG. 3.

In an embodiment, the price trend module 102 is configured to calculate a price change trend for one or more materials that are procured by the enterprise. In particular, the price trend module 102 uses a price change trend workflow to calculate the price change trend for each material. In some examples, the price trend module 102 calculates a price change trend for a material in response to a trigger, such as a user input requesting the calculation, a determination by the price trend module 102 that a new vendor for the material is available, or a determination by the price trend module 102 that a quantity of the material in the enterprise's inventory is less than a threshold. In other examples, the price trend module 102 periodically calculates the price change trend for a material, such as on a monthly, quarterly, or yearly basis. As described below, the price trend module 102 calculates price change trends using purchase orders (POs) that are stored in a PO database. The PO database may be a centralized analytics repository for data associated with the procurement of materials. For example, all transactional data for an enterprise can be collected and stored in the centralized analytics repository, where other systems of the enterprise, such as the IMS 100, may access the data.

FIG. 2 illustrates an example workflow 200 for calculating a price change trend of a material, according to some implementations. For clarity of presentation, the description that follows generally describes the workflow 200 in the context of components in other figures of this description. However, it will be understood that the workflow 200 can be performed, for example, by any suitable system, environment, software, hardware, or a combination of systems, environments, software, and hardware, as appropriate. In some implementations, various steps of the workflow 200 can be run in parallel, in combination, in loops, or in any order.

At step 202, the price trend module 102 calculates a current weight of a material. To do so, the price trend module 102 first extracts from a PO database: (i) all POs for the material during a current period and (ii) respective costs associated with the extracted POs. The current period may, for example, be a current month or business quarter, or any other period of time (for example, days, weeks, months, or years) up to and including the date at which the workflow 200 is executed.

The price trend module 102 then calculates a sum of the costs of the extracted POs (that is, the POs for purchases of the material made during the current period). The price trend module 102 also calculates a sum of the costs of all the POs made during the current period (that is, the POs for all purchases made during the current period). Finally, to calculate the weight of the material, the price trend module 102 divides the total cost of the POs for the material by the total cost of all POs during the current period.

At step 204, the price trend module 102 calculates a current weighted unit price of the material. To do so, the price trend module 102 first calculates a unit price weight for each PO of the material by dividing each PO cost by a total material placement value during the current period, where the total material placement value is a total value procured for the material during the current period. Then, the price trend module 102 multiplies the unit price weight for each PO with an effective unit price of each PO. The effective unit price, which is extracted from the PO database, is a total cost of the material including a material's unit price, customs duties, and logistics. Then, the price trend module 102 sums the weighted unit prices of all POs for the material to obtain the current weighted unit price of the material.

At step 206, the price trend module 102 checks for at least one of an International Commercial Term (incoterm) of the material, purchasing office that procured the material, and order unit of measurement of the material. Determining the at least one of these factors for the material allows the price trend module 102 to perform the subsequent steps of the workflow 200 using data that is also associated with all of these factors. Doing so will increase the accuracy of the calculated price change trends. For example, when calculating a weighted average price of the material over a historical period, only historical price change trends associated with the at least one of the same purchasing office, same incoterm, and same unit of measure are used in the calculation.

At step 208, the price trend module 102 calculates a weighted average price of the material over a historical period. The weighted average price of the material is an average of all values of the weighted unit price of the material that were calculated during the historical period. For example, if the weighted unit price of the material is calculated on a quarterly basis, the weighted average price of the material is the average of the values of the weighted unit price that were calculated on a quarterly basis in the historical period. The historical period may be on the order of days, weeks, months, or years. In an example, the historical period precedes the current period such that the historical period does not overlap with the current period. In another example, a start date of the historical period may precede the current period, but an end date of the historical period may overlap with the current period. In one example, the historical period is two years.

At step 210, the price trend module 102 calculates a difference between the current weighted unit price and the historical weighted average price. At step 212, the price trend module 102 calculates a material price percentage change by dividing the difference between the current weighted unit price and the historical weighted average price by the historical weighted average price. At step 214, the price trend module 102 calculates a weighted average percentage change by multiplying the material price percentage change by the current weight of the material (calculated in step 202).

In an embodiment, the price trend module 102 executes the workflow 200 to calculate the price change trend for more than one material. In particular, by executing the workflow 200 for more than one material, the price trend module 102 can calculate overall price change trends for the enterprise based on the price change trends of the more than one material. In some embodiments, the workflow 200 considers other factors that can increase the accuracy of the calculated price change trends. Such factors include an International Commercial Term (incoterm) of the material, the purchasing office that procured the material, and the unit of measurement in which the order was placed. For example, when calculating a weighted average price of the material over a historical period, only historical price change trends associated with the same purchasing office, same incoterm, or same unit of measure are used in the calculation.

In an embodiment, the price trend module 102 stores each price change trend in a central database of the IMS 100 (not illustrated in FIG. 1). Additionally, the price trend module 102 stores identifying data with each price change trend, such as the material and time period with which the price change trend is associated. The price trend modules that are stored in the central database can be used at a later time as historical data for calculating new price change trends. Additionally, the IMS 100 can perform actions in connection with the calculated trends (for example, an action based on a price change trend).

Returning to FIG. 1, the resource planning module 104 is configured to analyze the stored price change trends and to perform actions in connection with the trends. In an embodiment, the resource planning module 104 analyzes the price change trends, using statistical analysis, to generate data indicative of the prices of the materials procured by the enterprise. This data can be used to compare the enterprise's procured prices with market prices. Additionally, this data can be used to predict future prices of materials. Further, this data can be used to build a procurement strategy for frequently procured materials with a specific price and a specific vendor in order to avoid price uncertainty. Yet further, this data can be used to provide visibility on high spend materials and signify a cost impact of those materials. The cost impact can be used to show savings or additional costs associated with each of the high spend materials. As such, procurement strategies can be established based on the data to generate purchase agreements for high impact materials in order to avoid increased costs. In some examples, the data can be represented using visual graphics, such as charts, plots, or graphs.

In another embodiment, the resource planning module 104 generates recommendations based on the calculated price change trends. For example, the resource planning module 104 can generate recommendations for which vendors to use, prices at which to purchase materials, and quantities to purchase. These recommendations can be provided to an inventory management or supply chain team of the enterprise.

In an embodiment, the resource planning module 104 can perform one or more analysis operations. For example, the analysis operations in the resource planning module 104 can include machine learning (ML) algorithms or artificial intelligence (AI) algorithms, for example, based on detection, failure, or prediction models. Such algorithms can be based on data-driven models, physics models, or models that are both physics- and data-driven. The analysis operations are performed to identify patterns in the data. In particular, the resource planning module 104 uses ML or AI techniques to analyze the calculated price change trends and to generate recommendations based on the trends. An ML model can be trained using price change trends that are calculated by the price trend module 102. As an example, an ML model can be trained to generate data indicative of the prices of the materials procured by the enterprise. As another example, an ML model can be trained to predict future prices of materials. As yet another example, an ML model can be trained to identify price change trends that are indicative of certain events (for example, rapidly changing price, sudden change in price, prices that deviate from the market, among other examples).

Generally, machine learning can encompass a wide variety of different techniques that are used to train a machine to perform specific tasks without being specifically programmed to perform those tasks. The machine can be trained using different machine learning techniques, including, for example, supervised learning, unsupervised learning, and reinforcement learning. In supervised learning, inputs and corresponding outputs of interest are provided to the machine. The machine adjusts its functions in order to provide the desired output when the inputs are provided. Supervised learning is generally used to teach a computer to solve problems in which are outcome determinative. In contrast, in unsupervised learning inputs are provided without providing a corresponding desired output. Unsupervised learning is generally used in classification problems. Reinforcement learning describes an algorithm which a machine makes decisions using trial and error. Feedback informs the machine when a good choice or bad choice is made. The machine then adjusts its algorithms accordingly. During the training process, different algorithms may be used, including among others, generalized linear regression (GLM).

In another embodiment, the resource planning module 104 performs an action in connection with the calculated price change trends. In an example, the resource planning module 104 can generate an alert (for example, audio or visual alert via a computing device) indicative of a threshold change in price (for example, threshold drop or increase in price). In another example, the resource planning module 104 can be connected across inventory and supply chain management, which includes manufacturing, storage, transportation, and logistics, such that the resource planning module 104 can provide options for and actually act on calculated price change trends. The resource planning module 104 can incorporate, connect to, communicate with, or otherwise participate in the exchange of information, data, and instructions with external vendors in order to autonomously perform supply chain and inventory management actions. Such actions include negotiating existing contracts, searching for new vendors, submitting offers, and creating orders.

The graphical user interface 106 is used to display a graphical user interface (GUI) on a display of a computing device. In particular, the graphical user interface 106 may use data visualization software that retrieves data from the IMS 100 and generates the data visualization. For example, the IMS 100 can store and execute software, such as an operating system or application modules. Application modules can include routines, programs, objects, components, or data structures that perform particular tasks or that implement particular inventory management functions. In an example, the graphical user interface 106 generates a GUI that shows price change trends, insights on the price change trends, and recommendations. Additionally, the GUI may include features for placing orders, modifying the data, generating visual graphics indicative of the data, generating business reports based on the data, and exporting the data.

FIG. 3 illustrates an example graphical user interface (GUI) 300, according to some implementations. As shown in FIG. 3, the GUI 300 includes a toolbar panel 310 and a main window 316. The toolbar panel 310 includes drop-down menu 312 that enables selection of a format in which the data is displayed, such as “Table,” “Graph,” or “Report.” In the example, of FIG. 3, the selected format is “Table.” As such, a table is displayed in window 316. As shown in FIG. 3, the table includes several column headers, including “Cal.year/quar” 306, “Material group” 302, and “Weighted Average Change,” 304. The column under the “Cal.year/quar” 306 header indicates the business quarter and year associated with the displayed data. The column under the “Material group” 302 header indicates materials for which price change trends are generated. And the column under the “Weighted Average Change” 304 header indicates the weighted average change for each displayed material.

The toolbar panel 310 also includes “Recommendation” button 314 that enables providing an instruction to the IMS 100 to generate recommendations based on the displayed data. Further, the toolbar panel 310 includes “Place Order” button 308 that enables providing an instruction to the IMS 100 to automatically place orders based on the displayed data. Other buttons and features are also possible.

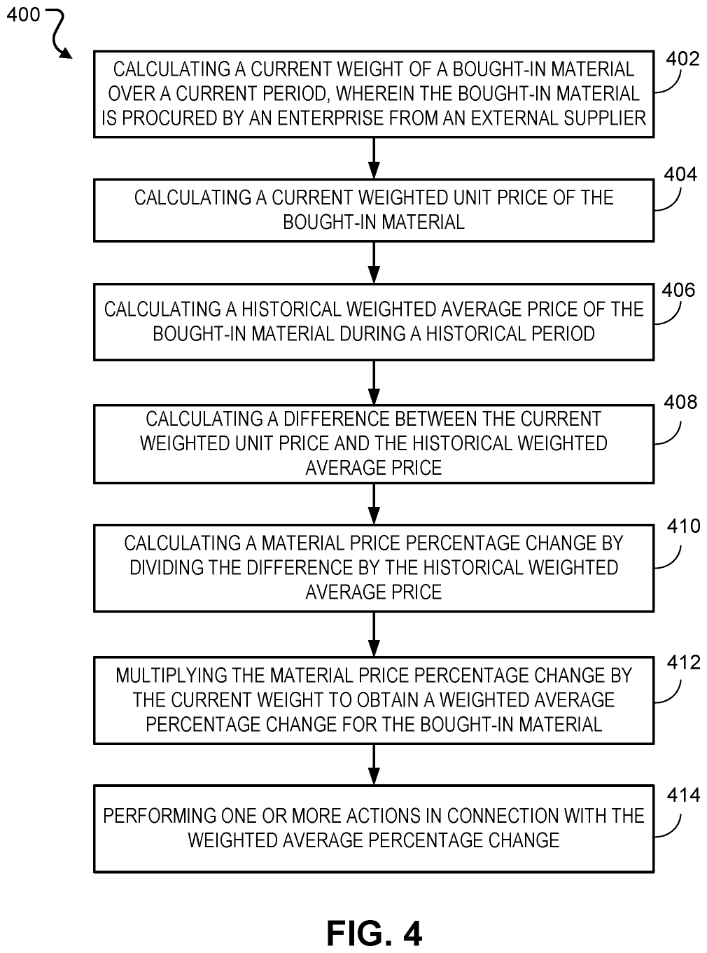

FIG. 4 is a flowchart of an example method 400, according to some implementations. The method 400 is for calculating price change trends for materials procured by an enterprise, and for performing actions in connection with the calculated trends. For clarity of presentation, the description that follows generally describes method 400 in the context of the other figures in this description. However, it will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order.

At step 402, method 400 involves calculating a current weight of a bought-in material over a current period, where the bought-in material is procured by an enterprise from an external supplier.

At step 404, method 400 involves calculating a current weighted unit price of the bought-in material.

At step 406, method 400 involves calculating a historical weighted average price of the bought-in material during a historical period.

At step 408, method 400 involves calculating a difference between the current weighted unit price and the historical weighted average price.

At step 410, method 400 involves calculating a material price percentage change by dividing the difference by the historical weighted average price.

At step 412, method 400 involves multiplying the material price percentage change by the current weight to obtain a weighted average percentage change for the bought-in material.

At step 414, method 400 involves performing one or more actions in connection with the weighted average percentage change.

In some implementations, calculating the current weight of the bought-in material involves: extracting from a purchase order database: (i) a plurality of purchase orders for the bought-in material during the current period and (ii) costs associated with the plurality of purchase orders; calculating a total cost of the plurality of purchase orders for the bought-in material; calculating a total cost of all purchase orders during the current period; and dividing the total cost of the plurality of purchase orders for the bought-in material by the total cost of all purchase orders to obtain the current weight of the bought-in material.

In some implementations, calculating the current weighted unit price of the bought-in material involves: for each of a plurality of purchase orders for the bought-in material: dividing a respective cost of the purchase order by a total material placement value during the current period to obtain a respective unit price weight; and multiplying the respective unit price weight with a respective effective unit price to obtain a respective weighted unit price; summing the respective weighted unit prices to obtain the current weighted unit price of the bought-in material.

In some implementations, the current weight of the material is calculated based on a plurality of purchase orders for the material during the current period, and wherein the plurality of purchase orders have at least one of an identical incoterm, purchasing office, or order unit of measurement.

In some implementations, performing one or more actions in connection with the weighted average percentage change involves: determining the weighted average percentage change and a threshold change in a price of the material; and responsively generating an alert indicative of the threshold change.

In some implementations, performing one or more actions in connection with the weighted average percentage change involves: generating, based on the weighted average percentage change, an offer for a purchase of the material; and submitting the offer to a system of an external vendor for the material.

In some implementations, performing one or more actions in connection with the weighted average percentage change involves: generating a representation of a graphical user interface (GUI), where the GUI contains: one or more panes including a representation of the weighted average percentage change.

In some implementations, method 400 further involves calculating respective weighted average percentage changes for a plurality of materials; and calculating, based on the respective weighted average percentage changes, an overall weighted average percentage change.

In some implementations, performing one or more actions in connection with the weighted average percentage change involves using ML or AI techniques to analyze the calculated price change trends and to generate recommendations based on the trends. An ML model can be trained using price change trends. As an example, an ML model can be trained to generate data indicative of the prices of the materials procured by the enterprise. As another example, an ML model can be trained to predict future prices of materials. As yet another example, an ML model can be trained to identify price change trends that are indicative of certain events (for example, rapidly changing price, sudden change in price, prices that deviate from the market, among other examples).

FIG. 5 is a block diagram of an example computer system 500 that can be used to provide computational functionalities associated with described algorithms, methods, functions, processes, flows, and procedures described in the present disclosure, according to some implementations of the present disclosure. In some implementations, the IMS 100 can be the computer system 500, include the computer system 500, or include part of the computer system 500. In some implementations, the IMS 100 can communicate with the computer system 500.

The illustrated computer 502 is intended to encompass any computing device such as a server, a desktop computer, embedded computer, a laptop/notebook computer, a wireless data port, a smart phone, a personal data assistant (PDA), a tablet computing device, or one or more processors within these devices, including physical instances, virtual instances, or both. The computer 502 can include input devices such as keypads, keyboards, and touch screens that can accept user information. Also, the computer 502 can include output devices that can convey information associated with the operation of the computer 502. The information can include digital data, visual data, audio information, or a combination of information. The information can be presented in a graphical user interface (UI) (or GUI). In some implementations, the inputs and outputs include display ports (such as DVI-I+2x display ports), USB 3.0, GbE ports, isolated DI/O, SATA-III (6.0 Gb/s) ports, mPCIe slots, a combination of these, or other ports. In instances of an edge gateway, the computer 502 can include a Smart Embedded Management Agent (SEMA), such as a built-in ADLINK SEMA 2.2, and a video sync technology, such as Quick Sync Video technology supported by ADLINK MSDK+. In some examples, the computer 502 can include the MXE-5400 Series processor-based fanless embedded computer by ADLINK, though the computer 502 can take other forms or include other components.

The computer 502 can serve in a role as a client, a network component, a server, a database, a persistency, or components of a computer system for performing the subject matter described in the present disclosure. The illustrated computer 502 is communicably coupled with a network 530. In some implementations, one or more components of the computer 502 can be configured to operate within different environments, including cloud-computing-based environments, local environments, global environments, and combinations of environments.

At a high level, the computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 530 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus. In some implementations, any or all of the components of the computer 502, including hardware or software components, can interface with each other or the interface 504 (or a combination of both), over the system bus. Interfaces can use an application programming interface (API), a service layer, or a combination of the API and service layer. The API can include specifications for routines, data structures, and object classes. The API can be either computer-language independent or dependent. The API can refer to a complete interface, a single function, or a set of APIs.

The service layer can provide software services to the computer 502 and other components (whether illustrated or not) that are communicably coupled to the computer 502. The functionality of the computer 502 can be accessible for all service consumers using this service layer. Software services, such as those provided by the service layer, can provide reusable, defined functionalities through a defined interface. For example, the interface can be software written in JAVA, C++, or a language providing data in extensible markup language (XML) format. While illustrated as an integrated component of the computer 502, in alternative implementations, the API or the service layer can be stand-alone components in relation to other components of the computer 502 and other components communicably coupled to the computer 502. Moreover, any or all parts of the API or the service layer can be implemented as child or sub-modules of another software module, enterprise application, or hardware module without departing from the scope of the present disclosure.

The computer 502 can include an interface 504. Although illustrated as a single interface 504 in FIG. 5, two or more interfaces 504 can be used according to particular needs, desires, or particular implementations of the computer 502 and the described functionality. The interface 504 can be used by the computer 502 for communicating with other systems that are connected to the network 530 (whether illustrated or not) in a distributed environment. Generally, the interface 504 can include, or be implemented using, logic encoded in software or hardware (or a combination of software and hardware) operable to communicate with the network 530. More specifically, the interface 504 can include software supporting one or more communication protocols associated with communications. As such, the network 530 or the interface's hardware can be operable to communicate physical signals within and outside of the illustrated computer 502.

The computer 502 includes a processor 505. Although illustrated as a single processor 505 in FIG. 5, two or more processors 505 can be used according to particular needs, desires, or particular implementations of the computer 502 and the described functionality. Generally, the processor 505 can execute instructions and can manipulate data to perform the operations of the computer 502, including operations using algorithms, methods, functions, processes, flows, and procedures as described in the present disclosure.

The computer 502 can also include a database 506 that can hold data for the computer 502 and other components connected to the network 530 (whether illustrated or not). For example, database 506 can be an in-memory, conventional, or a database storing data consistent with the present disclosure. In some implementations, database 506 can be a combination of two or more different database types (for example, hybrid in-memory and conventional databases) according to particular needs, desires, or particular implementations of the computer 502 and the described functionality. Although illustrated as a single database 506 in FIG. 5, two or more databases (of the same, different, or combination of types) can be used according to particular needs, desires, or particular implementations of the computer 502 and the described functionality. While database 506 is illustrated as an internal component of the computer 502, in alternative implementations, database 506 can be external to the computer 502.

The computer 502 also includes a memory 507 that can hold data for the computer 502 or a combination of components connected to the network 530 (whether illustrated or not). Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same, different, or combination of types) can be used according to particular needs, desires, or particular implementations of the computer 502 and the described functionality. While memory 507 is illustrated as an internal component of the computer 502, in alternative implementations, memory 507 can be external to the computer 502.

An application can be an algorithmic software engine providing functionality according to particular needs, desires, or particular implementations of the computer 502 and the described functionality. For example, an application can serve as one or more components, modules, or applications. Multiple applications can be implemented on the computer 502. Each application can be internal or external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion and management circuits, including recharging, standby, and power management functionalities. In some implementations, the power-supply 514 can include a power plug to allow the computer 502 to be plugged into a wall socket or a power source to, for example, power the computer 502 or recharge a rechargeable battery.

There can be any number of computers 502 associated with, or external to, a computer system including computer 502, with each computer 502 communicating over network 530. Further, the terms “client,” “user,” and other appropriate terminology can be used interchangeably, as appropriate, without departing from the scope of the present disclosure. Moreover, the present disclosure contemplates that many users can use one computer 502 and one user can use multiple computers 502.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification includes many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

1. A method comprising:
calculating, using a computing device, a current weight of a bought-in material over a current period, wherein the bought-in material is procured by an enterprise from an external supplier;
calculating, using the computing device, a current weighted unit price of the bought-in material;
calculating, using the computing device, a historical weighted average price of the bought-in material during a historical period;
calculating, using the computing device, a difference between the current weighted unit price and the historical weighted average price;
calculating, using the computing device, a material price percentage change by dividing the difference by the historical weighted average price;
multiplying, using the computing device, the material price percentage change by the current weight to obtain a weighted average percentage change for the bought-in material; and
performing, using the computing device, one or more actions in connection with the weighted average percentage change, wherein the one or more actions comprise generating a representation of a graphical user interface (GUI), wherein the GUI contains one or more panes including a representation of the weighted average percentage change.

2. The method of claim 1, wherein calculating, using the computing device, the current weight of the bought-in material comprises:
extracting, using the computing device and from a purchase order database, (i) a plurality of purchase orders for the bought-in material during the current period and (ii) costs associated with the plurality of purchase orders;
calculating, using the computing device, a total cost of the plurality of purchase orders for the bought-in material;
calculating, using the computing device, a total cost of all purchase orders during the current period; and
dividing, using the computing device, the total cost of the plurality of purchase orders for the bought-in material by the total cost of all purchase orders to obtain the current weight of the bought-in material.

3. The method of claim 1, wherein calculating, using the computing device, the current weighted unit price of the bought-in material comprises:
for each of a plurality of purchase orders for the bought-in material:
dividing, using the computing device, a respective cost of the purchase order by a total material placement value during the current period to obtain a respective unit price weight; and
multiplying the respective unit price weight with a respective effective unit price to obtain a respective weighted unit price;
summing the respective weighted unit prices to obtain the current weighted unit price of the bought-in material.

4. The method of claim 1, wherein the current weight of the material is calculated based on a plurality of purchase orders for the material during the current period, and wherein the plurality of purchase orders have at least one of an identical incoterm, purchasing office, or order unit of measurement.

5. The method of claim 1, wherein performing, using the computing device, one or more actions in connection with the weighted average percentage change comprises:
determining, the weighted average percentage change and a threshold change in a price of the material; and
responsively generating an alert indicative of the threshold change.

6. The method of claim 1, wherein performing, using the computing device, one or more actions in connection with the weighted average percentage change comprises:
generating, based on the weighted average percentage change, an offer for a purchase of the material; and
submitting the offer to a system of an external vendor for the material.

7. (canceled)

8. The method of claim 1, further comprising:
calculating respective weighted average percentage changes for a plurality of materials; and
calculating, based on the respective weighted average percentage changes, an overall weighted average percentage change.

9. A non-transitory computer-readable medium storing one or more instructions executable by a computer system to perform operations comprising:
calculating a current weight of a bought-in material over a current period, wherein the bought-in material is procured by an enterprise from an external supplier;
calculating a current weighted unit price of the bought-in material;
calculating a historical weighted average price of the bought-in material during a historical period;
calculating a difference between the current weighted unit price and the historical weighted average price;
calculating a material price percentage change by dividing the difference by the historical weighted average price;
multiplying the material price percentage change by the current weight to obtain a weighted average percentage change for the bought-in material; and
performing one or more actions in connection with the weighted average percentage change, wherein the one or more actions comprise generating a representation of a graphical user interface (GUI), wherein the GUI contains one or more panes including a representation of the weighted average percentage change.

10. The non-transitory computer-readable medium of claim 9, wherein calculating the current weight of the bought-in material comprises:
extracting, from a purchase order database, (i) a plurality of purchase orders for the bought-in material during the current period and (ii) costs associated with the plurality of purchase orders;
calculating a total cost of the plurality of purchase orders for the bought-in material;
calculating a total cost of all purchase orders during the current period; and
dividing the total cost of the plurality of purchase orders for the bought-in material by the total cost of all purchase orders to obtain the current weight of the bought-in material.

11. The non-transitory computer-readable medium of claim 9, wherein calculating the current weighted unit price of the bought-in material comprises:
for each of a plurality of purchase orders for the bought-in material:
dividing a respective cost of the purchase order by a total material placement value during the current period to obtain a respective unit price weight; and
multiplying the respective unit price weight with a respective effective unit price to obtain a respective weighted unit price;
summing the respective weighted unit prices to obtain the current weighted unit price of the bought-in material.

12. The non-transitory computer-readable medium of claim 9, wherein the current weight of the material is calculated based on a plurality of purchase orders for the material during the current period, and wherein the plurality of purchase orders have at least one of an identical incoterm, purchasing office, or order unit of measurement.

13. The non-transitory computer-readable medium of claim 9, wherein performing one or more actions in connection with the weighted average percentage change comprises:
determining, the weighted average percentage change and a threshold change in a price of the material; and
responsively generating an alert indicative of the threshold change.

14. The non-transitory computer-readable medium of claim 9, wherein performing one or more actions in connection with the weighted average percentage change comprises:
generating, based on the weighted average percentage change, an offer for a purchase of the material; and
submitting the offer to a system of an external vendor for the material.

15. (canceled)

16. The non-transitory computer-readable medium of claim 9, the operations further comprising:
calculating respective weighted average percentage changes for a plurality of materials; and
calculating, based on the respective weighted average percentage changes, an overall weighted average percentage change.

17. A system, comprising:
one or more processors; and
a non-transitory computer-readable storage medium coupled to the one or more processors and storing programming instructions for execution by the one or more processors, the programming instructions instructing the one or more processors to perform operations comprising:
calculating a current weight of a bought-in material over a current period, wherein the bought-in material is procured by an enterprise from an external supplier;
calculating a current weighted unit price of the bought-in material;
calculating a historical weighted average price of the bought-in material during a historical period;
calculating a difference between the current weighted unit price and the historical weighted average price;
calculating a material price percentage change by dividing the difference by the historical weighted average price;
multiplying the material price percentage change by the current weight to obtain a weighted average percentage change for the bought-in material; and
performing one or more actions in connection with the weighted average percentage change, wherein the one or more actions comprise generating a representation of a graphical user interface (GUI), wherein the GUI contains one or more panes including a representation of the weighted average percentage change.

18. The system of claim 17, wherein calculating the current weight of the bought-in material comprises:
extracting, from a purchase order database, (i) a plurality of purchase orders for the bought-in material during the current period and (ii) costs associated with the plurality of purchase orders;
calculating a total cost of the plurality of purchase orders for the bought-in material;
calculating a total cost of all purchase orders during the current period; and
dividing the total cost of the plurality of purchase orders for the bought-in material by the total cost of all purchase orders to obtain the current weight of the bought-in material.

19. The system of claim 17, wherein calculating the current weighted unit price of the bought-in material comprises:
for each of a plurality of purchase orders for the bought-in material:
dividing a respective cost of the purchase order by a total material placement value during the current period to obtain a respective unit price weight; and
multiplying the respective unit price weight with a respective effective unit price to obtain a respective weighted unit price;
summing the respective weighted unit prices to obtain the current weighted unit price of the bought-in material.

20. (canceled)
